(19) United States
(12) Patent Application Publication
(10) Pub. No.: US 2009/0160310 A1
(43) Pub. Date: Jun. 25, 2009

(54) DISCHARGE LAMP AND LIGHTING SYSTEM

(76) Inventors: Atsushi Motoya, Shiga (JP); Naomi Masuda, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/298,006

(22) PCT Filed: Dec. 21, 2007
(86) PCT No.: PCT/JP2007/074632

§ 371 Date: Oct. 21, 2008

(51) Int. Cl. H01J 63/04

(52) U.S. Cl. 313/485

(57) ABSTRACT

A discharge lamp 1 satisfies relations of α₁−α₂≧3×10⁻⁷ and α₂>α₃, where α₁ represents a thermal expansion coefficient [1/K] of a material of lead wires 5b and 6b, α₂ represents a thermal expansion coefficient of a material of bead glasses 3 and 4, and α₃ represents a thermal expansion coefficient of a material of a glass bulb 2. The discharge lamp 1 also satisfies relation of S₁<S₂, where S₁ represents a strain point [° C.] of the material of the bead glasses 3 and 4 and S₂ represents the material of the glass bulb 2. In the discharge lamp 1, tensile strains are unlikely to be created on the bead glasses or the glass bulb. As a result, a sealing part of the discharge lamp 1 can hardly crack during manufacture of the lamp.

### TECHNICAL FIELD

The present invention relates to a discharge lamp having a glass bulb whose ends are sealed with bead glasses, and to a lighting fixture having the discharge lamp.

### BACKGROUND ART

In a discharge lamp with the above structure, it is desirable that thermal expansion coefficients of materials of the bead glass and a lead wire attached to the bead glass for supplying electricity are closely analogous to each other. Furthermore, it is desirable that thermal expansion coefficients of materials of the glass bulb and the bead glass are also closely analogous to each other. That is to say, it is desirable that the thermal expansion coefficients of the materials of the lead wire, the bead glass, and the glass bulb are nearly equal to each other.

If the thermal expansion coefficients of the materials of the lead wire and the bead glass are closely analogous to each other, the bead glass can hardly strain in a sealing process where the end of the glass bulb is sealed with the bead glass. In addition, if the thermal expansion coefficients of the materials of the bead glass and the glass bulb are closely analogous to each other, the glass bulb can hardly strain in the sealing process. As a result, a sealing part of the lamp can hardly crack during manufacture of the lamp.

For example, Patent Document 1 discloses, in a discharge lamp whose lead wire is made of tungsten, a thermal expansion coefficient of glass forming a bead glass thereof is approximated to a thermal expansion coefficient of tungsten. Patent Document 2 discloses that, in a discharge lamp whose lead wire is made of Kovar, a thermal expansion coefficient of glass forming a glass bulb thereof is approximated to a thermal expansion coefficient of Kovar.

Patent Document 1: Japanese Published Unexamined Patent Application No. H6-203800
Patent Document 2: Japanese Published Unexamined Patent Application No. H10-69887

### DISCLOSURE OF THE INVENTION

### Problems the Invention is Attempting to Solve

Unfortunately, merely approximating the thermal expansion coefficients cannot sufficiently suppress the occurrence of the strains on the bead glass and the glass bulb. Therefore, the sealing part can crack during the manufacture of the lamp.

It is an object of the present invention to provide a discharge lamp where strains can hardly occur on a bead glass or glass bulb thereof and consequently a sealing part thereof can hardly crack during manufacture of the lamp. Furthermore, it is also an object of the present invention to provide a highly productive lighting fixture having such a discharge lamp.

### Means for Solving the Problems

To achieve the above object, an embodiment in accordance with the present invention provides a discharge lamp including a pair of electrodes each composed of an electrode body and a lead wire, a pair of bead glasses into each of which a different one of the lead wires is inserted, and a glass bulb of which both ends are sealed with the bead glasses. The following relations are satisfied: α₁−α₂≧3×10⁻⁷; and α₂>α₃, where al represents a thermal expansion coefficient (1/K) of a material of the lead wire, α₂ represents a thermal expansion coefficient (1/K) of a material of the bead glasses, and α₃ represents a thermal expansion coefficient (1/K) of a material of the glass bulb. Furthermore, the following relation is satisfied: S₁<S₂, where S₁ represents a strain point (° C.) of the material of the bead glasses, and S₂ represents a strain point (° C.) of the material of the glass bulb.

Another embodiment in accordance with the present invention provides a lighting fixture having the above discharge lamp.

### EFFECTS OF THE INVENTION

The discharge lamp in accordance with an embodiment of the present invention satisfies the first, second and third relations. Firstly, the thermal expansion coefficient [1/K] α₁ of the material of the lead wire and the thermal expansion coefficient α₂ of the material of the bead glass satisfy the first relation of α₁−α₂≧3×10⁻⁷. In other words, the thermal expansion coefficient α₁ of the material of the lead wire is larger than the thermal expansion coefficient α₂ of the material of the bead glass by 3×10⁻⁷ or more. Secondly, the thermal expansion coefficient α₂ of the material of the bead glass and the thermal expansion coefficient α₃ of the material of the glass bulb satisfy the second relation of α₂>α₃. In other words, the thermal expansion coefficient α₂ of the material of the bead glass is larger than the thermal expansion coefficient α₃ of the material of the glass bulb. Thirdly, the strain point S₁ of the material of the bead glass and the strain point S₂ of the material of the glass bulb satisfy the third relation of S₁<S₂. In other words, the strain point S₂ of the material of the glass bulb is larger than the strain point S₁ of the material of the bead glass.

In the sealing process where the end of the glass bulb is sealed with the bead glass, since the sealing part is heated by a burner from the outside of the glass bulb, the temperature of the glass bulb rises higher than that of the bead glass, and the temperature of the bead glass rises higher than that of the lead wire. Accordingly, if the thermal expansion coefficient α₁ of the material of the lead wire is identical with the thermal expansion coefficient α₂ of the bead glass, an amount of the expansion of the bead glass is larger than that of the lead wire. If the thermal expansion coefficient α₂ of the material of the bead glass is identical with the thermal expansion coefficient α₃ of the glass bulb, an amount of the expansion of the glass bulb is larger than that of the bead glass. Thus, if there is a difference between the amounts of the expansion, the bead glass and the glass bulb strain, which causes the sealing part to crack. In addition, when the heated glass bulb and bead glass are cooled down, the temperature of the glass bulb is still higher than that of the bead glass. Accordingly, if the strain point S₁ of the material of the bead glass and the strain point S₂ of the material of the glass bulb are identical with each other, the bead glass with a lower temperature reaches the strain point earlier and is cured to such a degree that the stress of the bead glass cannot be alleviated. Thus, if solely the bead glass is cured earlier, strains are more likely to be created.

On the other hand, since the discharge lamp of the present invention satisfies the first relation, there can be little difference in the amounts of the expansion of the lead wire and the bead glass. In addition, since the discharge lamp satisfies the second relation, there is little difference in the amounts of the expansion of the bead glass and the glass bulb. Furthermore, since the discharge lamp satisfies the third relation, when cooled down, the heated glass bulb and bead glass reach the strain point at closer timings.

Accordingly, in the sealing process, the bead glass and the glass bulb are unlikely to strain, and consequently, the sealing part can hardly crack. The detail is described later.

Note that, in this description, a thermal expansion coefficient indicates an average linear expansion coefficient in a range of 30-380° C. The strain point [° C.] indicates a temperature of glass whose viscosity η is log η=14.5.

The lighting fixture of the present invention is highly productive because the discharge lamp whose sealing part can hardly crack during the manufacture of the lamp is employed as its light source.

### BRIEF DESCRIPTION OF THE DRAWINGS

FIG. 1 is a partially cutout plan view of a discharge lamp in accordance with an embodiment of the present invention;

FIG. 2 shows material characteristics of discharge lamps in accordance with examples and evaluation results of a thermal shocking test;

FIG. 3 shows material characteristics of discharge lamps in accordance with the examples and evaluation results of the thermal shocking test;

FIGS. 4A, 4b and 4C show a process for attaching a bead glass to an electrode;

FIGS. 5A and 5B show a sealing process for sealing an end of a glass bulb with the bead glass;

FIG. 6 is a schematic view of main components of a lighting fixture in accordance with an embodiment of the present invention;

FIG. 7 shows strains occurred on the sealing part; and

FIG. 8 shows material characteristics of discharge lamps in accordance with comparative examples and evaluation results of the thermal shocking test.

### REFERENCE NUMERALS

1 discharge lamp
2 glass bulb
3, 4 bead glass
5, 6 electrode
5a, 6a electrode body
5b, 6b lead wire

### BEST MODE FOR CARRYING OUT THE INVENTION

The following describes a discharge lamp and a lighting fixture in accordance with an embodiment of the present invention, with reference to the attached figures.

### <Discharge Lamp>

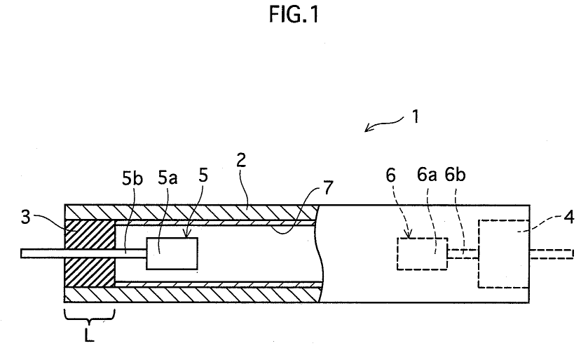

FIG. 1 is a partially cutout plan view of a discharge lamp in accordance with an embodiment of the present invention. As shown in FIG. 1, a discharge lamp 1 in accordance with the present invention is a cold cathode fluorescent lamp used as a light source of a lighting fixture such as a backlight unit. The discharge lamp 1 includes a glass bulb 2, a pair of bead glasses 3 and 4 that seal respective ends of the glass bulb 2, and a pair of electrodes 5 and 6 attached to the pair of the bead glasses 3 and 4, respectively.

The glass bulb 2 is in a straight-tube shape whose outer diameter is, for example, 1.4-7 mm, and whose wall thickness is 0.2-0.7 mm. On an inner circumferential surface of the glass bulb 2, a phosphor layer 7 of, for example, 10-30 μm is formed. Inside the glass bulb 2, mercury and rare gases unshown in the figure are enclosed.

The bead glasses 3 and 4 are each, for example, in a cylindrical shape. The bead glasses 3 and 4 are welded to respective ends of the glass bulb 2. Note that each of the bead glasses 3 and 4 does not have to be cylindrical, but may be in a spherical shape, for example.

The electrodes 5 and 6 are respectively composed of electrode bodies 5a and 6a and lead wires 5b and 6b that supplies electricity. The electrode bodies 5a and 6a are each in a stick shape and are made of nickel (Ni), niobium (Nb) or the like. The electrode bodies 5a and 6a opposing each other are provided within the glass bulb 2. Note that each of the electrode bodies 5a and 6a does not have to be in a stick shape, but may be in a bottomed-tubular shape, which is so-called a hollow electrode.

One end of each the lead wires 5b and 6b is connected to a respective one of the electrode bodies 5a and 6a, with use of, for example, welding. Another end of each of the lead wires 5b and 6b hermetically passes through a respective one of the bead glasses 3 and 4 and extends to the outside of the glass bulb 2. The material of the lead wires 5b and 6b is tungsten (W) whose thermal expansion coefficient is 43×10⁻⁷/K. Note that the lead wires 5b and 6b do not have to be made of tungsten, and may be made of molybdenum (Mo) whose thermal expansion coefficient is 51×10⁻⁷/K, or Kovar (alloy of iron-nickel-cobalt) whose thermal expansion coefficient is 53×10⁻⁷/K. In addition, when the bead glasses 3 and 4 and the glass bulb 2 are made of soft glass, the lead wires 5b and 6b may be made of Dumet whose thermal expansion coefficient in a radial direction is 94×10⁻⁷/K.

The following describes glass that is a material of the bead glasses 3 and 4 and the lead wires 5b and 6b.

The thermal expansion coefficient 2 of the glass of the bead glasses 3 and 4 is smaller than the thermal expansion coefficient α₁ of the material of the lead wire at least by 3×10⁻⁷/K. For example, when the lead wire is made of tungsten (thermal expansion coefficient is 43×10⁻⁷/K), the thermal expansion coefficient α₂ of the glass of the bead glasses 3 and 4 is 40×10⁻⁷/K or less.

The thermal expansion coefficient α₃ of the glass of the glass bulb 2 is smaller than the thermal expansion coefficient α₂ of the glass of the bead glasses 3 and 4. The strain point S₂ of the glass of the glass bulb 2 is larger than the strain point S₁ of the glass of the bead glasses 3 and 4.

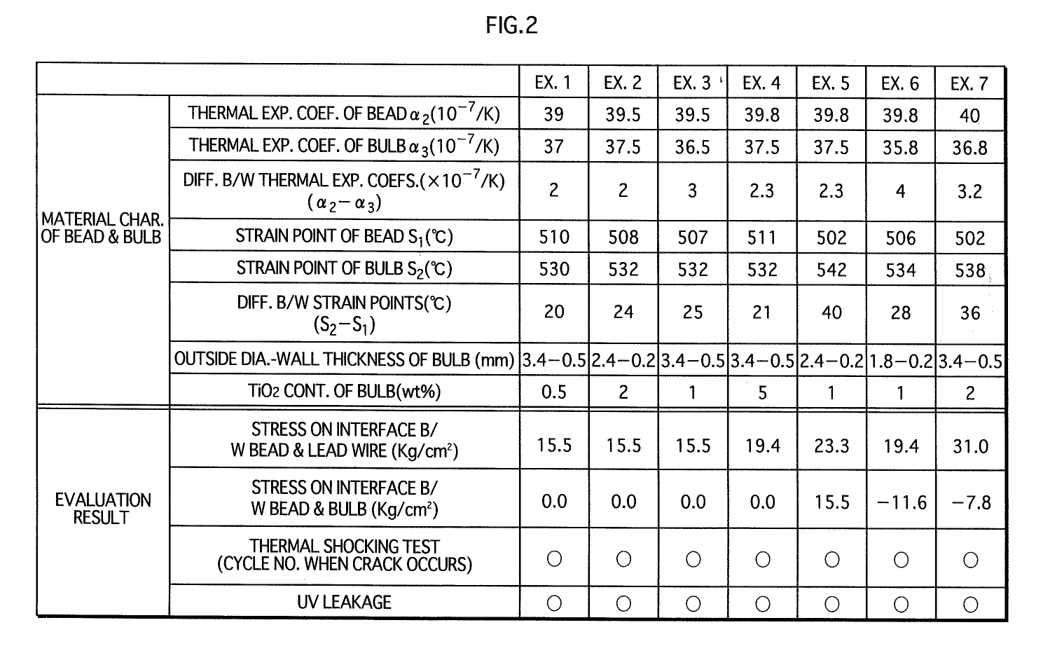

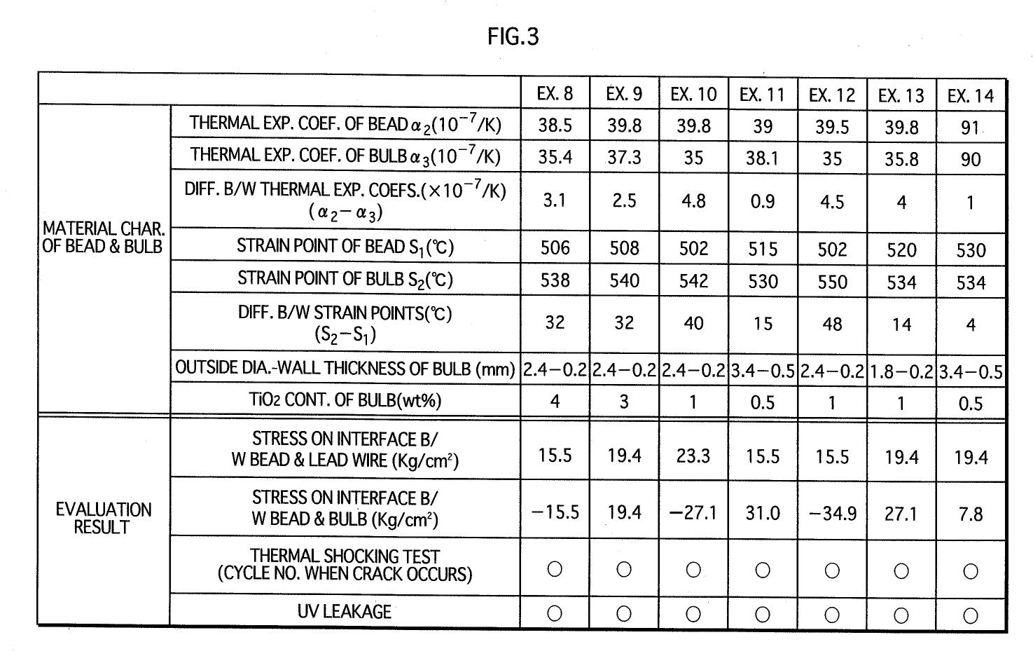

FIGS. 2 and 3 each show material characteristics of a discharge lamp in accordance with examples and evaluation results of a thermal shocking test. When the lead wires 5b and 6b are made of tungsten, for example, the glass bulb 2 and the bead glasses 3 and 4 can be made of materials having characteristics as shown in the examples 1-13 of FIGS. 2 and 3. When the lead wires 5b and 6b are made of Dumet, for example, the glass bulb 2 and the bead glasses 3 and 4 can be made of materials having characteristics as shown in the example 14 of FIG. 3.

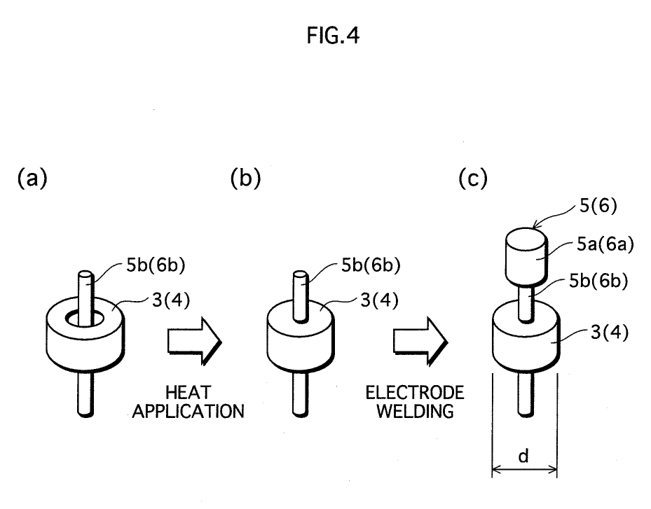

The following describes a method for manufacturing the discharge lamp 1. FIGS. 4A, 4B and 4C show a process for attaching the bead glass to the electrode.

In the process where the bead glasses 3 and 4 are attached to the electrodes 5 and 6, as shown in FIG. 4A, firstly, the lead wires 5b and 6b are inserted into hole parts of the bead glasses 3 and 4, respectively, and then heat-treated in hydrogen atmosphere. More specifically, the lead wires 5b and 6b are heated for 5-6 minutes in a hydrogen furnace at temperatures between 900-1200° C. (e.g. 1150° C.). Thus, when heated in the hydrogen atmosphere, since there can hardly be a difference in temperatures between the bead glasses 3 and 4 and the lead wires 5b and 6b, the bead glasses 3 and 4 are unlikely to strain. Note that the method for attaching the lead wires 5b and 6b to the bead glasses 3 and 4 is not limited to the heat processing in the hydrogen atmosphere. For example, the attaching process is performed by heat processing with use of a burner.

The bead glasses 3 and 4 are melted by the heat processing, and welded to the lead wires 5b and 6b. As shown in FIG. 4B, the bead glasses 3 and 4 and the lead wires 5b and 6b are integrated, respectively, with the lead wires 5b and 6b hermetically passing through the bead glasses 3 and 4. Subsequently, as shown in FIG. 4C, the electrode bodies 5a and 6a are welded to respective ends of the lead wires 5b and 6b.

It is desirable that the outside diameter d of each of the bead glasses 3 and 4 to a respective one of which the lead wires 5b and 6b has been attached, (shown in FIG. 4C) is 60-80% of the inside diameter of the glass bulb 2. When the outside diameter d is excessively small, it is occasionally difficult to form a robust sealing part. On the other hand, when the outside diameter d of each of the bead glasses 3 and 4 is excessively large, it is difficult to keep good ventilation within the glass bulb 2 in the subsequent sealing process.

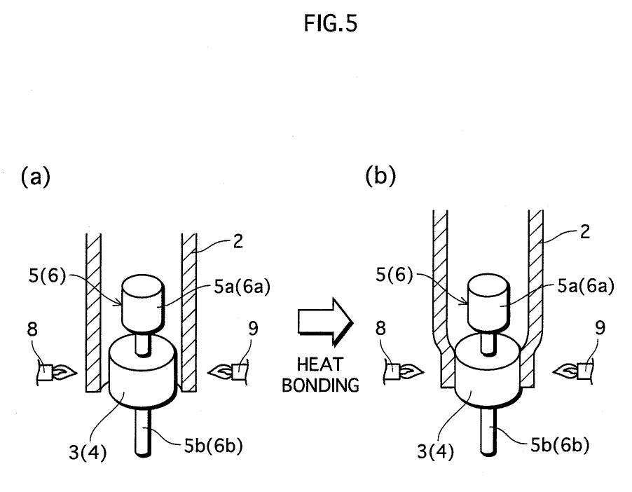

FIGS. 5A and 5B show the sealing process for sealing the end of the glass bulb with the bead glass. As shown in FIG. 5A, in the sealing process, the bead glasses 3 and 4 to which the electrodes 5 and 6 are attached are inserted into respective end parts of the glass bulb 2. As shown in FIG. 5B, the end parts are heated, for example, by burners 8 and 9 from the outside of the glass bulb 2 for 5-10 seconds at temperatures in a range between 900-1200° C. After being softened, the glass bulb 2 and the bead glasses 3 and 4 are welded together, and then annealed for 3 seconds at 650° C. Thus, the sealing part is formed, with the lead wires 5b and 6b hermetically passing through the bead glasses 3 and 4, respectively.

Up to this point, according to the embodiment, the structure of the discharge lamp and the manufacturing method in accordance with the present invention is specifically described. However, the present invention is not limited to the above embodiment.

For example, the discharge lamp of the present invention is not limited to a cold cathode fluorescent lamp, and may be a hot cathode fluorescent lamp having a filament at an electrode body thereof.

In addition, the glass bulb does not have to be in a straight-tube shape. The glass bulb may be in an annular shape, U-shape, spiral shape or the like. A section of the glass bulb does not have to be in a circular shape but may be in a flat shape.

The glass bulb is desirably made of glass delivering the following performance.

When a given amount of oxide of a transition metal is doped into the glass of the glass bulb according to a type of the glass, the glass is able to absorb ultraviolet rays with wavelengths of 254 nm and 313 nm. For example, on the condition that the oxide is titanium oxide (TiO₂), when the titanium oxide at the composition ratio of 0.05 mol % or more is doped to the glass, the glass is able to absorb ultraviolet rays with a wavelength of 254 nm. When the titanium oxide at the composition ratio of 2 mol % or more is doped to the glass, the glass is able to absorb ultraviolet rays with a wavelength of 313 nm. However, doping the titanium oxide at the composition ratio of 5 mol % or more causes devitrification of the glass. Thus, it is desirable to dope the titanium oxide at the composition ratio within a range between 0.05 mol % and 5 mol %, inclusive.

On the condition that the oxide is cerium oxide (CeO₂), when the cerium oxide at the composition ratio of 0.05 mol % or more is doped to the glass, the glass is able to absorb ultraviolet rays with a wavelength of 254 nm. However, doping the cerium oxide at the composition ratio of 0.5 mol % or more causes discoloration of the glass. Thus, it is desirable to dope the cerium oxide at the composition ratio within a range between 0.05 mol % and 0.5 mol %, inclusive. Note that doping tin oxide (SnO) as well as cerium oxide to the glass serves to prevent the discoloration of the glass. Thus, the cerium oxide at the composition ratio of up to 5 mol % can be doped. In this case, when the cerium oxide at the composition ratio of 0.5 mol % or more is doped to the glass, the glass can absorb ultraviolet rays with a wavelength of 313 nm. Note that also in this case doping the cerium oxide at the composition ratio of 5 mol % or more causes the devitrification of the glass.

On the condition that the oxide is zinc oxide (ZnO), when the zinc oxide at the composition ratio of 2 mol % or more is doped to the glass, the glass is able to absorb ultraviolet rays with a wavelength of 254 nm. However, doping the zinc oxide at the composition ratio of 10 mol % or more causes a rise in a thermal expansion coefficient of the glass. When the lead wire is made of tungsten, a difference is observed between the thermal expansion coefficient of tungsten and the thermal expansion coefficient α₂ of the material of the bead glass, which makes it difficult to attach the lead wire to the bead glass. Thus, it is desirable to dope the zinc oxide at the composition ratio within a range between 2 mol % and 10 mol %, inclusive. Note that when the lead wire is made of molybdenum or Kovar, since the thermal expansion coefficients of molybdenum and Kovar are higher than that of tungsten, the zinc oxide at the composition ratio of up to 14 mol % can be doped to the glass. However, doping the zinc oxide at the composition ratio of 20 mol % or more may cause the devitrification of the glass. Therefore, it is desirable to dope the zinc oxide at the composition ratio within a range between 2 mol % and 20 mol %, inclusive.

On the condition that the oxide is ferric oxide (Fe₂O₃), when the ferric oxide at the composition ratio of 0.01 mol % or more is doped to the glass, the glass is able to absorb ultraviolet rays with a wavelength of 254 nm. However, doping the ferric oxide at the composition ratio of 2 mol % or more causes the discoloration of the glass. Thus, it is desirable to dope the ferric oxide at the composition ratio within a range between 0.01 mol % and 2 mol %, inclusive.

It is desirable to control an infrared ray transmittance coefficient X indicating a water content of the glass to fall within a range between 0.3-1.2, inclusive, and more desirably in a range between 0.4-0.8, inclusive. When the infrared ray transmittance coefficient X is 1.2 or less, it is easy to obtain a low dielectric tangent applicable to a high voltage application lamp such as an external electrode fluorescent lamp (EEFL) or a long cold cathode fluorescent lamp. When the infrared ray transmittance coefficient X is 0.8 or less, the dielectric tangent is low enough to be applicable to a higher voltage application lamp.

Note that the infrared ray transmittance coefficient X is expressed by the following Expression 1.

X=(log(a/b))/t Expression 1
a: transmittance % of minimum point in vicinity of 3840 cm⁻¹
b: transmittance % of minimum point in vicinity of 3560 cm⁻¹
t: thickness of glass

### <Lighting Fixture>

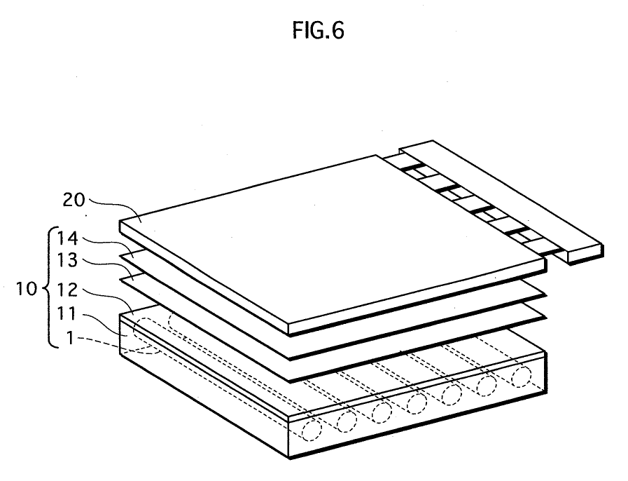

FIG. 6 is a schematic view of main components of a lighting fixture in accordance with an embodiment of the present invention. A lighting fixture 10 in accordance with the embodiment of the present invention is a linear-type backlight unit, and the structure thereof conforms to the structure of a conventional backlight unit.

As shown in FIG. 6, the lighting fixture 10 includes a plurality of discharge lamps 1, an envelope 11, a diffuser plate 12, a diffuser sheet 13, and a lens sheet 14.

The envelope 11 is in a box shape and is made of white PET (polyethylene terephthalate) resin. The envelope 11 is composed of a bottom plate that is approximately in a square shape and serves as a reflector plate and a side plate that encloses the bottom plate. Inside the envelope 11, a plurality of the discharge lamps 1 equally spaced from one another are stored. The envelope 11 has an opening part provided at an opposite position to the bottom plate across the discharge lamps 1. This opening part is in a direction in which light is outputted.

The diffuser plate 12 is made of PC resin, and is arranged to cover the opening part of the envelope 11. Furthermore, a side of the diffuser plate 12 in the direction in which light is outputted is overlaid with the diffuser sheet 13 made of the PC resin and the lens sheet 14 made of acrylic resin.

In a liquid crystal television having the above lighting fixture 10, an LCD panel 20 of the liquid crystal television is arranged on a side of the lens sheet 14 in the direction in which light is outputted.

A typical example of the lighting fixture 10 is one employed by a liquid crystal television having a 32-inch screen. In that case, the envelope 11 is approximately 728 mm in width, 408 mm in height and 19 mm in depth. In addition, the envelope 11 has sixteen of the discharge lamps 1 therein being arranged at an interval of approximately 25.7 mm.

### <Strain on Sealing Part>

In the sealing process, when the glass bulb 2 and the bead glasses 3 and 4 are heated, the temperature of the glass bulb 2 rises higher than those of the bead glasses 3 and 4 because of the following reason. The glass bulb 2 is directly flamed by the burners 8 and 9. On the other hand, since the bead glasses 3 and 4 are made of glass with relatively low thermal conductivity, heat generated by the burners 8 and 9 is not easily transmitted to the bead glasses 3 and 4. Accordingly, if the thermal expansion coefficients of the glass bulb 2, the bead glasses 3 and 4 are identical with each other, the glass bulb 2 shows a larger amount of the expansion than the bead glasses 3 and 4. Therefore, when the glass bulb 2 and the bead glasses 3 and 4 are cooled down, the glass bulb 2 shows a larger amount of shrinkage than the bead glasses 3 and 4. Accordingly, residual strains are observed on the glass bulb 2, with the glass bulb 2 tightening the bead glasses 3 and 4.

In addition, the bead glasses 3 and 4 that are closer to the flames of the burners 8 and 9 have higher temperatures than the lead wires 5b and 6b. Accordingly, if the thermal expansion coefficients of the bead glasses 3 and 4 and the lead wires 5b and 6b are identical with each other, the bead glasses 3 and 4 show larger amounts of the expansion than the lead wires 5b and 6b. Therefore, when the bead glasses 3 and 4 and the lead wires 5b and 6b are cooled down, the bead glasses 3 and 4 show larger amounts of shrinkage than the lead wires 5b and 6b. Accordingly, residual strains are observed on the bead glasses 3 and 4, with the bead glasses 3 and 4 tightening the lead wires 5b and 6b, respectively.

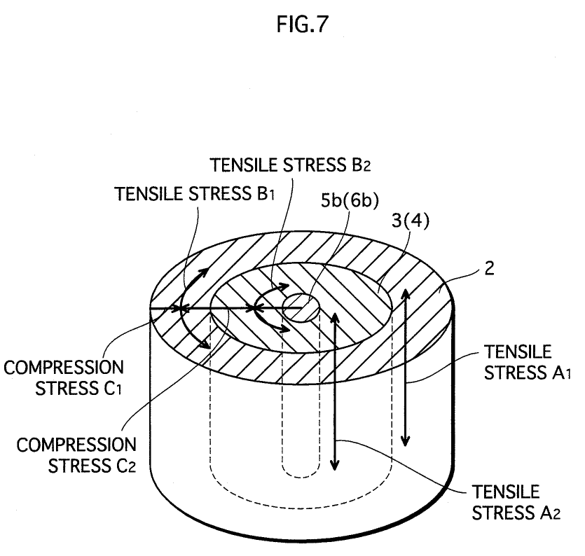

FIG. 7 shows strains occurred on the sealing part. A conventional discharge lamp cannot sufficiently prevent the occurrence of strains on a sealing part thereof.

In general, strains are occurred on interfacial surface of the glass bulb 2 facing the bead glasses 3 and 4, and the interfacial surfaces of the bead glasses 3 and 4 facing the lead wires 5b and 6b, respectively. As shown in FIG. 7, these strains are generated by a tensile stress A₁ of the glass bulb 2 in a longitudinal direction, namely a tube axis direction of the glass bulb 2, a tensile stress A₂ of the bead glass 3 or 4 in the longitudinal direction, and a tensile stress B₁ of the glass bulb 2 in a circumferential direction, a tensile stress B₂ of the bead glass 3 or 4 in a circumferential direction, a compression stress C₁ of the glass bulb 2 in a radial direction, and a compression stress C₂ of the bead glass 3 or 4 in the radial direction. These residual stresses A₁, A₂, B₁, B₂, C₁ and C₂ enable the glass bulb 2 to tighten the bead glasses 3 and 4 from the outside, and also enable the bead glasses 3 and 4 to tighten the lead wires 5b and 6b, respectively, from the outside.

While glass is originally robust against a compression stress, the glass is weak at a tensile stress. For that reason, mainly the tensile stresses A₁ and B₁ generate tensile strains on the interfacial surfaces of the glass bulb 2 facing the bead glasses 3 and 4, and consequently the glass bulb 2 cracks. In addition, the tensile stresses A₂ and B₂ generate tensile strains on the interfacial surfaces of the bead glasses 3 and 4 facing the lead wires 5b and 6b, respectively, and consequently the bead glasses 3 and 4 crack. Since especially the wall thickness of the glass bulb 2 is as thin as 0.2-0.7 mm, the tensile strains occurred on the glass bulb 2 cause breakage of the sealing part, which decreases the reliability of the sealing.

The following describes the tensile strains generated on the interfacial surfaces of the bead glasses 3 and 4 facing the lead wires 5b and 6b, respectively. The tensile strains allow the bead glasses 3 and 4 to appropriately tighten the lead wires 5b and 6b, respectively, which improves the joint strength of the interfacial surfaces between the lead wires 5b and 6b and the bead glasses 3 and 4, and the reliability of the sealing by the sealing part. However, if the tensile strains remain too strong, the tensile strains in the circumferential direction cause the sealing part to crack, which decreases the reliability of the sealing.

The discharge lamp 1 of the present invention satisfies the relation of α₁−α₂≧3×10⁻⁷/K with respect to the relation between the bead glasses 3 and 4 and the lead wires 5b and 6b. α₁ represents a thermal expansion coefficient of a material of the lead wires 5b and 6b. α₂ represents a thermal expansion coefficient of a material of the bead glasses 3 and 4. Thus, strains occurred on the bead glasses 3 and 4 are remarkably suppressed. In addition, appropriate compression stresses remain in a radial direction on interfacial surfaces of the lead wires 5b and 6b and the bead glasses 3 and 4, which improves the sealing reliability. If the relation of α₁−α₂≧3×10⁻⁷/K is not satisfied, the strains on the interfacial surfaces of the lead wires 5b and 6b and the bead glasses 3 and 4 grow, which may cause the bead glasses 3 and 4 to crack.

With respect to the relation between the glass bulb 2 and the bead glasses 3 and 4, since the bead glasses 3 and 4 have lower temperatures than the glass bulb 2, the thermal expansion coefficient of the material of the bead glasses 3 and 4 is larger than the thermal expansion coefficient of the material of the glass bulb 2. Accordingly, amounts of the expansion of the glass bulb 2 and the bead glasses 3 and 4 are closely analogous with each other, which remarkably prevents the occurrence of strains on the glass bulb 2. The thermal expansion coefficient of the material of the bead glasses 3 and 4 needs to be larger than that of the material of the glass bulb 2. The difference in their thermal expansion coefficients is desirably in a range between 2×10⁻⁷/K-4×10⁻⁷/K, inclusive.

In the sealing process, however, since the glass bulb 2 has a higher temperature than the bead glasses 3 and 4, a material whose strain point is higher than those of the bead glasses 3 and 4 is used for the glass bulb 2. Hence, not only the amounts of the expansion but also curing speeds of the glass bulb 2 and bead glasses 3 and 4 become equal to each other, which is more unlikely to cause strains.

More specifically, if the strain points of the materials of the glass bulb 2, and the bead glasses 3 and 4 are equal to each other, the bead glasses 3 and 4 with lower temperatures are cured earlier. Accordingly, even though the thermal expansion coefficients of the materials of the glass bulb 2 and the bead glasses 3 and 4 are controlled, the bead glasses 3 and 4 having been cured earlier are tightened by the glass bulb 2 that is to be cured later, which causes residual strains. However, if the glass bulb 2 and the bead glasses 3 and 4 reach their strain points almost at the same time, the glass bulb 2 and the bead glasses 3 and 4 shrink at the same time, which can hardly cause the strains.

The curing speed in this description means necessary time for materials to have the same viscosity. The strain point of the material of the glass bulb 2 needs to be larger than the strain point of the material of the bead glasses 3 and 4. The difference in their strain points desirably is in a range between 20-40° C. If this range is not satisfied, strong tensile strains are generated in the glass bulb 2.

If the materials of the glass bulb 2, the bead glasses 3 and 4, and the lead wires 5b and 6b satisfy all the above characteristics, the discharge lamp 1 with extraordinarily high sealing reliability can be achieved.

### <Evaluation of Discharge Lamp>

Various samples of the discharge lamp in accordance with the present invention were manufactured, and with use of the samples, residual strains and cracks on the sealing part were evaluated. The following describes the evaluation method.

The discharge lamp samples in accordance with the examples 1-13 shown in FIGS. 2 and 3 are as follows. A material of a glass bulb and a bead glass is hard glass. A material of a lead wire is tungsten, and an outside diameter thereof is 0.3 mm. A material of an electrode body is nickel, and the total length there of is 4 mm and an outside diameter thereof is 1.2 mm. A phosphor layer is made of a three-band phosphor and is 15 μm thick. Rare gases enclosed therein are a neon-argon gas mixture charged at 80 Torr. A content of mercury enclosed therein is 2 mg.

As for a discharge lamp sample in accordance with the example 14 shown in FIG. 3, a material of a glass bulb and a bead glass is soft glass, and a material of a lead wire is Dumet. Other structure is basically identical with those of the discharge lamp samples of the examples 1-13.

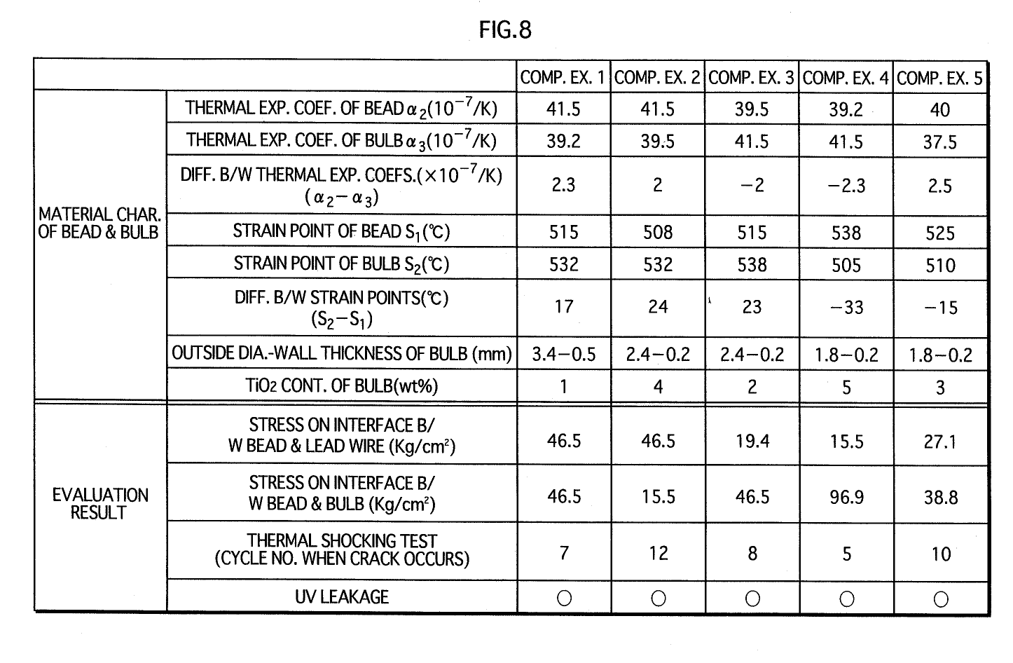

FIG. 8 shows evaluation results of the thermal shocking test and material characteristics of discharge lamp samples in accordance with comparative examples 1-5. The structure of each discharge lamp sample of the comparative examples 1-5 shown in FIG. 8 is basically identical with those of the discharge lamp samples of the examples 1-13.

A glass bulb and a bead glass of each lamp sample are made of glass tubes manufactured as follows. Glass materials were prepared to have prescribed material characteristics.

The glass materials were put into a glass fusion furnace, melted at temperatures of 1500-1600° C. so as to get vitrified, and thus glass melt was obtained. The glass melt was formed into a tubular shape through a tube drawing process such as Danner Process, and was cut into a specified length. Thus, the glass tubes were achieved.

The residual strains on the sealing part were evaluated based on the stress on the interfacial surface between the bead glass and the lead wire and the stress on the interfacial surface between the bead glass and the glass bulb. These stresses were calculate as follows. Firstly, strains on the interfacial surface between the bead glass and the lead wire and strains on the interfacial surface between the bead glass and the glass bulb were measured. Secondly, the measured results were applied into Expression 2 to obtain a phase difference. Thirdly, the obtained phase difference was applied into Expression 3.

R=θ·λ/180 Expression 2

R: phase difference

θ: strain angle (°)

λ: wavelength of monochrome light (nm)

F=R/(c·t) Expression 3

F: stress (kg/cm²)

c: optical elasticity constant (kgf/cm²)

t: thickness of sample (cm)

The strain angle θ was measured with a polarimeter (manufactured by Shinko Seiki Co., Ltd.: SPII type). Note that the wavelength λ of monochrome light measured with the polarimeter was 589 nm.

Note that a part of the discharge lamp being cut out for a length L in the tube axis direction as shown in FIG. 1 was used as a sample for the measurement. This sample is obtained as follows. After cutting off a part of the lead wire that projects outward from the discharge lamp, solely the sealing part is separated from the discharge lamp. This sample is in a cylindrical shape.

The strain angle θ was measured by letting the light enter the sample in the tube axis direction. Since the length L of each of the discharge lamp samples for the experiment is 0.3 cm, a thickness t of the sample is 0.3 cm.

The optical elasticity constant c of the hard glass used for the discharge lamp samples of the examples 1-13 and the comparative examples 1-5 is 3.87. The optical elasticity constant c of the soft glass used for the example 14 is 2.71. The optical elasticity constant c of lead-free glass is 2.65.

The following discusses values of the stress F shown in FIGS. 2, 3 and 8. When the stress F is formed in any of the arrow directions as shown in FIG. 7, the strain angle θ is obtained as a positive number. When the stress F is formed in an opposite direction to the arrow direction, the strain angle θ is obtained as a negative number. Accordingly, when the stress F is a positive number, the stress F is formed in any of the arrow directions. When the stress F is a negative number, the stress F is formed in the opposite direction. In addition, the larger the value F is, the larger a residual stress is.

The thermal shocking test was carried out on the sealing part. The sealing part underwent the thermal shocking test as follows. After the sealing part was immersed in an iced tank with a low temperature for 3 seconds, the sealing part was immersed in a soldering tank with the constant temperature of 300° C. The above process is considered as one cycle, and evaluation was made by observing at which cycle the sealing part cracked. When the sealing part did not crack after undergoing twenty of the cycles, the sealing part was evaluated as good, which is put as “◯” in the figures.

In the examples 1-4, the thermal expansion coefficient α₂ of the material of the bead glass is larger than the thermal expansion coefficient α₃ of the material of the glass bulb, and the difference between α₂ and α₃ falls within a range between 2×10⁻⁷/K-3×10⁻⁷/K, inclusive. In addition, the strain point S₂ of the material of the glass bulb is higher than the strain point S₁ of the material of the bead glass, and the difference between S₁ and S₂ falls within a range between 20-30° C. Since the thermal expansion coefficient α₂ of the material of the bead glass is 40×10⁻⁷/K or less, which is smaller than the thermal expansion coefficient of tungsten (43×10⁻⁷/K) by 3×10⁻⁷/K, the strains occurred on the interfacial surface of the glass bulb toward the bead glass are completely suppressed. Thus, the stress F is 0. A discharge lamp having such a sealing part does not crack even after the thermal shocking test is conducted for twenty cycles. In addition, since a given amount of TiO₂ is contained in the glass bulb, ultraviolet rays do not leak from the lamp.

In the examples 5-9, the thermal expansion coefficient α₂ of the material of the bead glass is larger than the thermal expansion coefficient α₃ of the material of the glass bulb, and the difference between α₂ and α₃ falls within a range between 1×10⁻⁷/K-4×10⁻⁷/K. In addition, the strain point S₂ of the material of the glass bulb is higher than the strain point S₁ of the material of the bead glass, and the difference between S₁ and S₂ falls within a range between 20-40° C. Since the thermal expansion coefficient α₂ of the material of the bead glass is 40×10⁻⁷/K or less, the stress F on the interfacial surface between the bead glass and the glass bulb is remarkably small (absolute value of the stress F is 20 kg/cm² or less).

In the examples 10-13, the thermal expansion coefficient α₂ of the material of the bead glass is larger than the thermal expansion coefficient α₃ of the material of the glass bulb. The strain point S₂ of the material of the glass bulb is higher than the strain point S₁ of the material of the bead glass. However, in the examples 10-12, the difference between α₂ and α₃ does not fall within the range of 1×10⁻⁷/K-4×10⁻⁷/K. Neither does the difference between S₁ and S₂ fall within a range between 20-40° C. Thus, the stress F on the interfacial surface between the bead glass and the glass bulb is somewhat large (absolute value of the stress F falls within a range between 20-35 kg/cm²). However, in the examples 10-13, crack does not occur even after the thermal shocking test is conducted for twenty cycles. Thus, the stress F is deemed acceptable.

Mentioned as above, as for the examples 1-13, the thermal expansion coefficient α₂ of the material of the bead glass is larger than the thermal expansion coefficient α₃ of the material of the glass bulb, and the strain point S₂ of the material of the glass bulb is higher than the strain point S₁ of the material of the bead glass. Accordingly, the stress F on the interfacial surface between the bead glass and the glass bulb falls within the acceptable range of 35 kg/cm² or less. In addition, the thermal expansion coefficient α₂ of the material of the bead glass is 40×10⁻⁷/K or less, which is smaller than the thermal expansion coefficient of tungsten (43×10⁻⁷/K) by 3×10⁻⁷/K, and the stress F on the interfacial surface between the bead glass and the lead wire and the stress F on the interfacial surface between the bead glass and the lead wire fall within the acceptable range. Thus, remarkable strains do not occur on the interfacial surfaces, and crack does not occur even after the thermal shocking test is conducted for twenty cycles.

As for the comparative example 1, since the thermal expansion coefficient α₂ of the material of the bead glass is larger than 40×10⁻⁷/K, strong stress remains on the interfacial surface between the bead glass and the lead wire, which creates remarkable strains on the interfacial surface. In addition, neither does the difference between S₁ and S₂ fall within the range between 20-40° C. Thus, strong stress remains on the interfacial surface between the bead glass and the glass bulb, which creates remarkable strains on the interfacial surface.

As for the comparative example 2, since the thermal expansion coefficient α₂ of the material of the bead glass is larger than 40×10⁻⁷/K, strong stress remains on the interfacial surface between the bead glass and the lead wire, which creates remarkable strains on the interfacial surface.

As for the comparative examples 3 and 4, the thermal expansion coefficient α₃ of the material of the glass bulb is larger than the thermal expansion coefficient α₂ of the material of the bead glass. Accordingly, strong stresses remain on the interfacial surface between the glass bulb and the bead glass, which creates remarkable strains. Furthermore, in the comparative example 4, since the strain point S₁ of the material of the bead glass is higher than the strain point S₂ of the material of the glass bulb, stronger stresses remain on the interfacial surface between the bead glass and the glass bulb, which creates strong strains on the interfacial surface.

As for the comparative example 5, the thermal expansion coefficient has given characteristics. However, since the strain point S₁ of the material of the bead glass is higher than the strain point S₂ of the material of the glass bulb, stronger stresses remain on the interfacial surface between the bead glass and the glass bulb, which creates remarkable strains on the interfacial surface.

In the comparative examples 1-5, the strong residual stresses create remarkable strains. For that reason, a discharge lamp in accordance with the comparative examples 1-5 cannot endure twenty or more of the cycles of the thermal shocking test.

### INDUSTRIAL APPLICABILITY

The present invention is applicable to discharge lamps as a whole, including a fluorescent lamp such as a straight tube fluorescent lamp, a circular fluorescent lamp, a double circular fluorescent lamp, a square fluorescent lamp, a double square fluorescent lamp, and a twin fluorescent lamp, and a mercury vapor discharge lamp.

1. A discharge lamp including a pair of electrodes each composed of an electrode body and a lead wire, a pair of bead glasses into each of which a different one of the lead wires is inserted, and a glass bulb of which both ends are sealed with the bead glasses, wherein
the following relations are satisfied:
α₁−α₂≧3×10⁻⁷; and
α₂>α₃,
where
α₁ represents a thermal expansion coefficient (1/K) of a material of the lead wire, α₂ represents a thermal expansion coefficient (1/K) of a material of the bead glasses, and α₃ represents a thermal expansion coefficient (1/K) of a material of the glass bulb, and
the following relation is further satisfied:
S₁<S₂,
where
S₁ represents a strain point (° C.) of the material of the bead glasses, and S₂ represents a strain point (° C.) of the material of the glass bulb.

2. The discharge lamp of claim 1, wherein
the following relations are satisfied:
1×10⁻⁷≦α₂−α₃≦4×10⁻⁷; and
20≦S₂−S₁≦40.

3. The discharge lamp of claim 1, wherein
the following relations are satisfied:
2×10⁻⁷≦α₂−α₃≦3×10⁻⁷; and
20≦S₂−S₁≦30.

4. The discharge lamp of claim 2, wherein
the material of the lead wire is one of tungsten, molybdenum, Kovar and Dumet.

5. A lighting fixture having a discharge lamp as defined in claim 1.
